(19) United States
(12) Patent Application Publication
(10) Pub. No.: US 2013/0129888 A1
(43) Pub. Date: May 23, 2013

(54) METHOD AND APPARATUS FOR TREATING FERMENTED LIQUIDS

(71) Applicant: Daniel C. Kornacki, North Tonawanda, NY (US)

(72) Inventor: Daniel C. Kornacki, North Tonawanda, NY (US)

(21) Appl. No.: 13/813,958

(22) PCT Filed: Sep. 17, 2011
(86) PCT No.: PCT/US11/52058

§ 371 Date: Feb. 4, 2013

(51) Int. Cl. C12H 1/16

(52) U.S. Cl. CPC C12H 1/16
USPC 426/487; 99/277.1; 99/277.2

(57) ABSTRACT

Provided are methods and apparatuses for the monitored and controlled removal of dissolved gasses and other vitriolic compounds from fermented liquid using evacuation, which can be mechanically enhanced, without fading or negatively impacting flavor, bouquet, complexity, balance or finish of the fermented liquid.

### CROSS-REFERENCE TO RELATED APPLICATIONS

This application claims priority to U.S. Provisional Patent Application No. 61/384,293, filed Sep. 19, 2010, the disclosure of which is incorporated herein by reference.

### FIELD OF THE INVENTION

This invention relates generally to the field of making and preparing fermented liquids and more particularly to removal of dissolved gasses and other possible vitriolic compounds from fermented liquids to improve the flavor and finish of the fermented liquid.

### BACKGROUND OF THE INVENTION

During the fermentation process of wine, yeast converts sugar into molecules of ethyl alcohol and carbon dioxide (CO₂). The CO₂ stays in solution in wine until the partial pressure of CO₂ exceeds the ambient pressure at the liquid-air interface. This process of removal, expelling, or diffusion of gas across the liquid-air interface, or evacuation of dissolved gas from a fermented liquid is referred to here as outgassing or degassing.

In addition to CO₂, other vitriolic compounds and compounds, such as free sulfur dioxide (SO₂), can be dissolved in fermented liquids such as wine. SO₂ forms in the wine from bisulfate compounds that can be added to the wine to extend the shelf life of bottled wine. These vitriolic compounds can be removed and currently acceptable methods for removing vitriolic compound such as dissolved CO₂ and SO₂ involve the use of atmospheric aeration where a bottle is opened and allowed to “sit out” to naturally aerate, or a mechanical aerator can be used as well to mix air with the wine as it is being poured.

The problem is that removing CO₂ and other vitriolic compounds can lead to the removal of the esters and other molecules which determine the bouquet, complexity, balance and finish of a wine. If CO₂ and other vitriolic compounds are removed in an inappropriate way, such as being removed entirely, or the levels of the compounds are lowered too much, the flavor of the fermented liquid can be negatively affected. The problem with existing methods for outgassing a fermented liquid is that current methods are unable to control the outgassing of vitriolic compounds from the liquid. Also, both open bottle aeration and mechanical aeration, can introduce too much oxygen into the wine. Oxygen can fade the wine, sometimes referred to as rusting a wine, which detracts from the finish and flavor of the wine. Winemakers have tried to combat that problem by adding potassium metabisulfite for storage and during aging to prevent absorption of oxygen, or dissolving or oxygen into fermented liquid. However, potassium metabisulfite in wine will release free SO₂ which is one of the vitriolic compounds that is sought to be reduced by aeration and outgassing. While the addition of preservation compounds do prevent too much oxygen absorption, it does not address the bigger problem of how to adequately measure when the wine is properly outgassed and ready for consumption at the height of the taste profile of the wine, while still preventing the introduction of oxygen that can negatively impact the flavor of wine.

Another problem in properly outgassing a fermented liquid like a wine is how to measure the amount of outgassing that has occurred, and properly timing when to stop an outgassing process to achieve a flavor profile that matches the taste of various consumers, i.e., measuring the speed and completeness of the outgassing process. Too little outgassing does not achieve the desired effect, while too much can also adversely impact flavor, bouquet, complexity, balance or finish. Therefore, there is a need in the art for a method and apparatus that can properly outgas a wine without introducing too much oxygen and that can measure the outgassing process and determine the proper time to consume the wine at the height of the flavor profile of the wine that matches individual preferences of a consumer.

### BRIEF SUMMARY

In an aspect, the present invention provides methods and apparatuses for the monitored and controlled removal of dissolved CO₂, SO₂ and/or other vitriolic compounds from fermented liquid using evacuation, which can be mechanically enhanced, without fading or negatively impacting flavor, bouquet, complexity, balance or finish of the fermented liquid.

In an aspect, the present invention provides a method of treating a fermented liquid. In an embodiment, treating a fermented liquid includes the steps of: a) exposing a fermented liquid to a stimulant to initiate outgassing of a gas dissolved in the fermented liquid; b) continuous monitoring of a flow rate of at least one dissolved gas outgassing from the fermented liquid; and stopping the outgassing of at least one gas from the fermented liquid when the flow rate reaches a desired range. Since there could be several different gasses other than CO₂ the term at least one gas may be used instead of saying just a gas, as there could potentially be several gasses that are outgassing from a fermented liquid. It is stated that the present invention provides a step of monitoring, but monitoring could also mean measuring of the flow rate of gas outgassing from the fermented liquid, or measuring of the partial pressure of the dissolved gas in the fermented liquid over time. The range of flow rate can be in a range from about 2.4 ml/min to 64.7 ml/min. The dissolved gas is selected from a group consisting of CO₂ and SO₂.

In an embodiment, the stimulant is a vacuum that lowers ambient pressure at a liquid-air interface of the fermented liquid, and the ambient pressure is lowered below a partial pressure of the gas (or gasses) dissolved in the fermented liquid. The method can also include a second stimulant that causes agitation of the fermented liquid to enhance outgassing of the dissolved gas from the fermented liquid. In one aspect, the method involves agitation directly or indirectly applied to the fermented liquid. Other examples involve a stimulant causing agitation of the fermented liquid to enhance outgassing of a dissolved gas from the fermented liquid. In other aspects, the fermented liquid is held within a container that is airtight and the ambient pressure is lowered by lowering pressure outside the container. In one aspect, outgassing occurs without introducing oxygen into the fermented liquid.

In one aspect, the present invention provides a method of treating a fermented liquid comprising the steps of: a) exposing the fermented liquid to an ambient pressure surrounding the fermented liquid that is lower than a partial pressure of at least one gas dissolved in the fermented liquid, and the lower ambient pressure initiates outgassing of a dissolved gas from the fermented liquid; b) continuous monitoring of a flow rate of the dissolved gas outgassing from the fermented liquid; and, c) stopping the outgassing of the dissolved gas from the fermented liquid when the flow rate reaches a desired range.

In yet another aspect, the present invention provides a device for treating a fermented liquid that comprises: a) a perturbation unit that initiates outgassing from a fermented liquid; b) a monitoring unit proximately connected to the perturbation unit, where the monitoring unit continuously monitors a flow rate of dissolved gas outgassing from the fermented liquid; and c) a signaling unit proximately connected to the monitoring device, wherein the signaling unit transmits a signal when the flow rate reaches a desired range. The desired range matches or falls within a range of about 2.4 ml/min to 64.7 ml/min. In one aspect, the perturbation unit is a vacuum pump that lowers an ambient pressure at a liquid-air interface of the fermented liquid to initiate outgassing from the fermented liquid. In one embodiment, the perturbation unit is an agitator that mechanically perturbs the fermented liquid to initiate outgassing from the fermented liquid. In one example, the agitator is an eccentric motor. In certain aspects, the agitator is positioned inside or outside the fermented liquid.

In one aspect, the device with the vacuum pump further comprises a second perturbation unit that is an agitator that mechanically perturbs the fermented liquid. In an aspect, the device of the present invention has a closure that seals the container when the flow rate reaches a desired range. In one embodiment, a control unit connecting the perturbation unit, the monitoring unit and the signaling unit, and the control unit controls and coordinates all components in the device.

### BRIEF DESCRIPTION OF THE FIGURES

FIG. 1 is a schematic block diagram showing an apparatus and method of the present invention.

FIG. 2 is a schematic showing an apparatus and method of the present invention.

FIG. 3 is a cross-sectional view of a device for monitoring the flow rate of gas outgassed from a liquid of the present invention.

FIG. 4 is a cross-sectional view of a device for monitoring the flow rate of gas outgassed from a liquid of the present invention.

### DETAILED DESCRIPTION OF THE INVENTION

The present invention provides methods and devices for the monitoring and controlling of the removal of dissolved and free gases, such as CO₂ and SO₂, and other vitriolic compounds, from fermented liquids. In many fermented liquids, there may be one, two or many dissolved gasses in the liquid. Throughout this description the term dissolved gasses and dissolved gas are used interchangeable as many fermented liquids may have several dissolved gasses, including CO₂ and SO₂ (and possibly others), where the predominant dissolved gas will be CO₂, or the fluid may have only a single dissolved gas, such as CO₂. Vitriolic compounds are any compounds that can negatively impact the flavor and taste of fermented liquids like wine. The present invention provides methods and apparatuses that are capable of being used to treat fermented liquid to alter of improve the flavor profile and chemical composition of any substance, particularly liquids, and more particularly fermented liquids, which includes: alcohol, liquor, wine, beer, champagne, bubbling wine, or similar substances. In an aspect of the invention, the disclosed methods and apparatuses include using evacuation without fading or negatively impacting bouquet, complexity, balance or finish. Throughout this description the terms outgassing, degassing, outgas and degas is intended to mean the removal, expelling, diffusion of gas across the liquid-gas boundary, or evacuation of dissolved gas from a fermented liquid. The outgassing process can include one gas, or a combination of gasses, and it can be artificially stimulated or enhanced by way of mechanical perturbation of the fermented liquid, or by adjusting the ambient pressure with which the fermented liquid is exposed.

Throughout this description the term liquid-air interface refers to the boundary where air meets the surface of a liquid, and equivalent terms used are: liquid-air boundary, liquid-gas boundary, liquid-gas interface, or similar terms known in the art. The surface area of the liquid-air interface can affect the rate the outgassing rate, hence the flow rate of gas outgassing from a container can be affected as well. As the surface area of the liquid-air interface increases the flow rate can be increased. The degree that the flow rate will be affected is minimal, but it can be considered. Typically, the devices and methods of the present invention would be used to monitor the outgassing of a fermented liquid in a standard 750 ml bottle. In cases where the devices and methods of the present invention are used with containers that provide a liquid-air interface that differs from a 750 ml bottle, the methods and devices of the present invention can be calibrated to account for the change in flow rate that could be generated by a larger or smaller liquid-air interface.

A present invention provides a method to speed the outgassing of vitriolic compounds in wine by using evacuation, which can be mechanically enhanced, to lower the ambient pressure at which the wine is exposed. This can speed the outgassing process and allow the partial pressure of CO₂ in contact with the wine to drop below ambient pressure to produce a superior finished wine. SO₂ and any others gasses dissolved in a fermented liquid can be outgassed via similar pressure conditions and mechanisms as described for CO₂ as described herein.

When the ambient pressure of the air at the liquid-air interface of a fermented liquid falls below the partial pressure of dissolved CO₂ in the fermented liquid, the dissolved gas will begin to outgas, and bubbles can rise to the liquid-air interface of the wine according to Boyle's law. This release of the dissolved CO₂ is called outgassing. Under a partial pressure of twice ambient pressure the outgassing occurs at a much slower rate without bubbles forming. Outgassing will stop at the point when the partial pressure of a dissolved gas in the liquid is equal to the partial pressure of that same gas in the gaseous mixture in contact with the liquid at the liquid-gas boundary.

Partial pressure can be calculated by multiplying total pressure of a gaseous mixture by the percentage of the gas in that mixture. For example, if the gaseous mixture above the liquid is 10% CO₂ and the pressure is one atmosphere or 14.7 pounds per square inch absolute (psia), the partial pressure of CO₂ in the gaseous mixture is 1.47 psia. Diffusion across the liquid-gas boundary is outgassing. In the example given above outgassing would stop when the partial pressure of dissolved CO₂ reached 1.47 psia and would slow as the partial pressure of dissolved CO₂ approached 1.47 psia.

CO₂ has several affects on wine some of which are beneficial, and some are not: 1. CO₂ preserves; 2. CO₂ adds acidity affecting the taste of wines, which can be beneficial as some wines need it because of low natural acid of the wine; 3. CO₂ makes wine bitter if there is too much; 4. Too little CO₂ makes a wine flat or flabby. The present invention recognizes that at the time of consumption there are a range of partial pressures of CO₂ that is optimal for proper acid balance and taste, and provides a method and apparatus for adjusting and monitoring the partial pressure of CO₂ in liquids. The present invention also recognizes and addresses that there are personal preferences for CO₂ partial pressures, and that the exact point within that optimal range is dictated by that consumer's personal preference for how they think a fermented liquid should taste. Too little CO₂ would upset acid balance and wine can taste flat or flabby. Too much CO₂ makes a wine taste bitter.

Prior techniques and devices that considered the impact of dissolved gas on wine (such as the Carbodoseur and other similar methods and devices) measure the total dissolved gas that has been outgassed at the end of a period. These previous techniques only determined the pre-processing amount of dissolved gas and the after the fluid has been maximally degassed. A fluid agitated in the Carbodoseur, is agitated until it can't be degassed any more by agitation. Other known previous techniques determined the amount of dissolved gas in a fluid by removing and testing a sample periodically. These previous techniques include titration, blood gas analyzers, CO₂ specific electrodes and the Carbodoseur. These techniques lack continuous real-time information feedback during degassing.

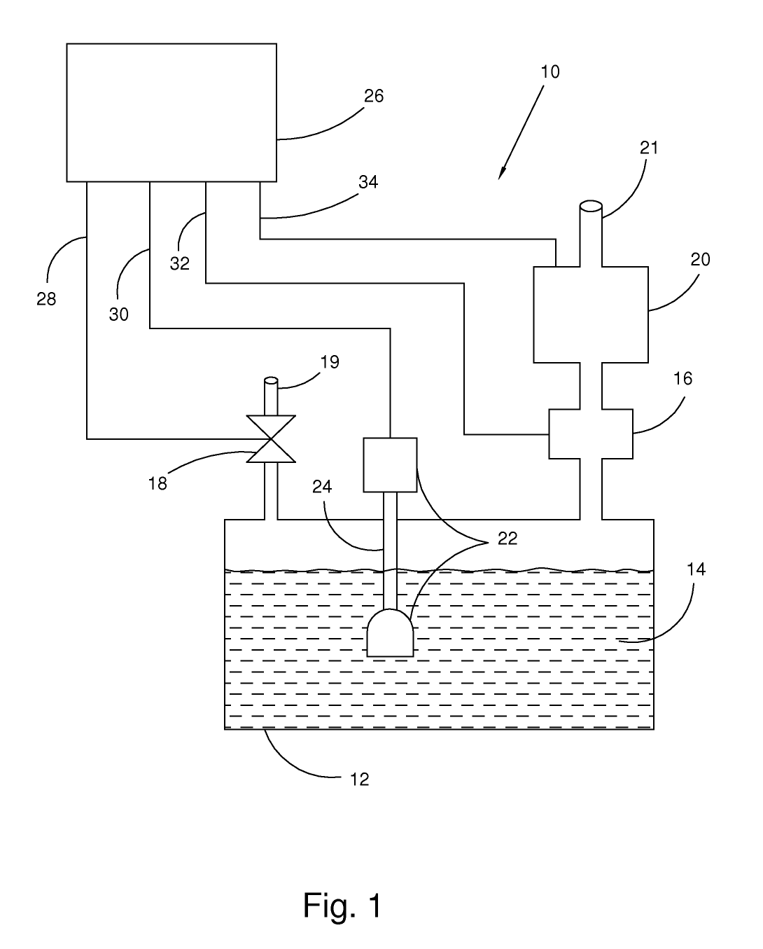

The present invention is represented schematically in a block diagram in FIG. 1. The present invention provides an apparatus 10 for removing vitriolic compounds, in particular dissolved gasses like CO₂ and SO₂, which are contained in many fermented liquids. Apparatus 10 is best used on a sealed container 12 capable of retaining a fluid 14. Examples of container 12 on which apparatus 10 would be attached include, but are not limited to: can, flask, jug, pitcher, tub, bottle, tank, barrel, chamber or any other closed vessel that is capable of holding liquid or capable of retaining a fluid holding container. Fluid 14 held in container 12 is the substance that is to be degassed, and is any substance that needs to be degassed to improve the flavor profile. Apparatus 10 is intended to be attached to a container 12 holding a fermented liquid, such as wine, that has been very recently opened, and which may contain compounds that can be detrimental to the flavor and finish of the liquid, such as certain dissolved gasses. Soon after opening container 12, a flow rate monitoring unit 16 is attached in a fashion that prevents the gasses that are outgassed from the fluid 14 from escaping without first flowing through or past flow rate monitoring unit 16. In one embodiment of the invention, unit 16 is removably attached to container 12 using a screw mechanism that enables unit 16 to have a female threading that interacts with a male threading on container 12, similar to a screw cap on a bottle. Removably means that unit 16 is attached in a way that will enables unit to be readily removed from container 12. Other aspects of the invention can use a method of attachment such as a compression cap, clamp, screw thread, clamp on, vacuum suction, mechanical clamp on outside, expanding insert, adhesive, magnets, gravity, stopper, or cork, or some similar means that secures unit 16 to container 12 in a way that accomplishes a seal that is airtight or very close to airtight.

CO₂ has a higher solubility in fermented liquid as opposed to water partially due to interactions between CO₂ molecules and proteins in the fermented liquid. The protein and CO₂ interact through electrostatic bonds as opposed to chemical bonds. To enhance or increase outgassing in a fermented liquid it may be necessary to apply an external ambient pressure that is significantly lower than the partial pressure of the dissolved gas in the fermented liquid, or it may be necessary to supply a mechanical stimulus to the fermented liquid. Mechanical perturbation and lowered ambient pressure can be applied together in the current methods and apparatuses, or the lowered ambient pressure and mechanical perturbation can be applied separately. Outgassing will occur in an open container at a slow rate driven by diffusion when the partial pressure of the dissolved gas in liquid is greater than the partial pressure of that same gas in the gaseous mixture in contact with the liquid at the liquid-gas boundary or interface. Partial pressure of a gas in a gaseous mixture is the decimal percentage of that gas times the absolute pressure of the mixture. For example, if the absolute pressure of a mixture of gasses is 14.7 psia, a one gas constituent makes up one percent of that mixture, the partial pressure of that one gas in the mixture is 0.147 psia or one hundredth the absolute pressure of the mixture.

In some aspects, the methods and apparatuses of the present invention implement some sort of mechanical excitement or perturbation to a fermented liquid to break the interaction between dissolved gas molecules, such as CO₂, and proteins to cause outgassing at a reasonable rate.

Flow rate measurement unit 16 is connected adjacent to evacuation unit 20, which can be a vacuum pump or a similar mechanism, which exposes fermented liquid 14 to an ambient pressure that is lower than the partial pressure of any dissolved gasses in fermented liquid 14. While outgassing may occur without applying a mechanical perturbation of the fermented liquid, or without subjecting the liquid to a vacuum system, it should be noted that the flow rate of gasses outgassing will be affected, and are likely to be higher, when the fermented liquid is under vacuum and or exposed to mechanical perturbation. In some aspects of the present invention, either mechanical perturbation or vacuum pressure (reducing ambient pressure of the gas mixture surrounding the liquid-air interface to a level that is lower than the partial pressure of the dissolved gas) can be applied separately or together to achieve a rate of outgassing that is desired. As ambient pressure surrounding the gas/liquid interface of fermented liquid 14 becomes lower than the partial pressure of any dissolved gas in the fermented liquid 14, that lower ambient pressure begins the evacuation (or outgassing) of gas from fermented liquid 14. In one aspect of the invention, evacuation unit 20 is a vacuum pump that removes gas molecules from a sealed volume in order to leave behind a partial vacuum. In some aspects, evacuation unit 20 evacuates gas, including free gas molecules, from container 12 through opening 21 as dissolved gas is outgassed from fluid 14 as free gas molecules. One example of a vacuum pump that would adequately suit the needs of evacuation unit 20 would be positive displacement pump that use a mechanism to repeatedly expand a cavity, allow gases to flow in from the chamber, seal off the cavity, and exhaust it to the atmosphere. One reason for implementing evacuation unit 20, such as a vacuum pump, is to prevent oxygen contact with fluid 14, which in the case of wine can lead to fading of the wine. Vacuum pump degassing allows a user to control the outgassing process. The point when the user decides to stop the outgassing process is sometimes referred to in this description as the set point, and the set point can be adjusted to meet the taste and preferences of the user of the present invention. The set point is the ideal time when the wine or fluid has been properly degassed and is just right for consumption for an individual user.

An optional component of apparatus 10 is a release valve 18, which is a valve that can opened to vent to the exterior of container 12 (e.g., venting to the atmosphere), or it can be closed to retain a pressure seal inside container 12. Once the degassing has proceeded to the optimal amount, and the evacuation unit 20 has been stopped, valve 18 can be opened manually or by control device 26 in order to equalize the pressure of container 12 to atmospheric pressure. This may be necessary if a vacuum has been formed inside container 12 from the functioning of evacuation unit 20, and a user has a difficult time removing apparatus 10. Equalizing the pressure in container 12 with the atmospheric pressure outside container 12 will enable any devices connected to container 12 to be removed, and will allow a user to remove fluid 14 from container 12. Release valve 18 relieves the vacuum of the container because the atmospheric pressure is greater than in the container and it reduces the effort to remove device 10. In some aspects, the surface area of the top of the container in contact with the apparatus 10 is small, or the vacuum effect may not be significant. Therefore, the force required to remove apparatus 10 would be small and relief valve 18 may not be necessary.

In some aspects of the current invention, the removal of dissolved gas from a fermented liquid utilizes an agitator 22 that disturbs the liquid 14 to enhance the outgassing of dissolved gasses and other vitriolic compounds. Agitator 22 can be directly in contact with liquid 14, or it can be attached directly or indirectly to external surface of container 12. In some aspects, agitator 22 is a device that vibrates, shakes or stirs the fluid 14 to a degree necessary to provide sufficient activation energy to commence or enhance outgassing. In some aspects of the invention, agitator 22 is a stirring rod, or magnetic stirring device that stirs of mechanically perturbs the liquid. In some aspects, agitator 22 implements sonic agitators or mechanical agitators. One example of a mechanical agitator is an eccentric motor that uses an electrical motor deliberately made out of balance by a counter weight away from the center of rotation hence the term eccentric motor. The out of balance weight causes vibration or shaking that agitates liquid 14. In another example of agitator 22, a wand 24 is put in contact with fluid 14 and a motor attached to wand 24, such as an eccentric motor, effectuates wand 24 to disturb liquid 14.

In some aspects, a control unit 26 controls or monitors the individual elements of apparatus 10, namely: flow rate monitoring device 16, release valve 18, evacuation unit 20, and agitator 22. Control device 26 can also allow a user to control the process and indicate or stop the process when a set point has been reached, i.e., the correct residual partial pressure of the gas in solution in the fluid is reached based on the flow rate of the gas being degassed from the fluid. It may be optimal to include a control unit 26 in the disclosed apparatuses and methods wherein the device can allow settings to be input by a user, it can display results through indicators, and it can have a digital display and/or it can implement audible sounds to alert a user of important events. In one aspect, control unit 26 also enables components of apparatus 10 to interact, where the speed and/or timing of operation of those components is adjusted based on the information/data that is sent from the individual components to control unit 26. Control unit 26 receives and transmits information from flow monitoring device 16 to control unit 26 along communication link 32. Control unit 26 receives and transmits information from evacuation unit 20 to control unit 26 along communication link 34. Control unit 26 receives and transmits information from agitator 22 to control unit 26 along communication link 30. Control unit 26 receives and transmits information from release valve 18 to control unit 26 along communication link 28.

In one example of the apparatus of the present invention a user attaches device 10 to a container holding a fluid and selects the desired level of partial pressure that the user desires to obtain for that fluid. After setting the desired partial pressure, i.e., the level of outgassing that is desired, a user would turn apparatus 10 on with a start button located on control unit 26. Optionally, pushing the start button illuminates a power on indicator. Turning the apparatus 10 on sends a signal to evacuation unit 20 to commence the evacuation of gas from container 12, and sends the partial pressure setting input by the user to flow rate monitoring unit 16 and that unit starts to continuously monitor the partial pressure change of fluid 14. If an agitator 22 is included in apparatus 10, the start button would also send a signal to agitator to commence the mechanical perturbation of fluid 14.

In one example of the invention, the desired partial pressure level is correlated to a pressure differential between container 12 and the exterior of the container, i.e., the pressure surrounding outlet 21. In such a case the flow rate monitoring unit 16 is a differential pressure switch monitoring the pressure difference on either side of the pressure differential switch, i.e., the pressure within container 12, and the pressure outside container 12. The differential pressure switch continuously monitors the pressure difference across the switch. As the partial pressure of dissolved gas in fluid 14 drops, due to outgassing of dissolved gas caused by the vacuum and/or mechanical perturbation, the flow rate of gas escaping fluid 14 decreases. As flow rate decreases the pressure drop across the differential pressure switch decreases until the set point is reached and that would signal the stopping of the degassing process. The normally open differential pressure switch can close and send a signal to control unit 26. Set point is the point that correlates to a partial pressure of the dissolved gasses in the fermented liquid when the outgassing should be stopped. In one aspect, the set point is adjustable and can be established by the user or can be selected as a predetermined point that most users would prefer. In one aspect, the set point is not adjustable. The signal indicating the set point correlates to the point when the desired partial pressure has been reached. Control unit then sends a signal to evacuation unit 20 to stop evacuating gas from container 12, and if an agitator 22 has been used, the mechanical perturbation would be stopped as well.

In one aspect, control unit 26 sends a signal to the user that the desired partial pressure has been reached and illuminates an indicator and/or sounds a buzzer indicating the outgassing process has completed. Release of any vacuum developed within container 12 can be accomplished by: opening pressure release valve 18 manually; by pushing a button on control unit 26 to open pressure release valve 18; or control unit 26 can open pressure release valve 18 when the desired partial pressure has been reached.

In another example of the invention, the desired partial pressure level is correlated to a flow rate of gas evacuating from container 12. Flow rate monitoring unit 16 is a flow rate monitoring device that can detect or monitor the gas pressure that is exerted against unit 16 from within container 12. The flow rate monitor 16 continuously monitors the pressure from container 12. As the partial pressure of dissolved gas in fluid 14 drops, due to outgassing of dissolved gas caused by the vacuum and/or mechanical perturbation, the flow rate of gas escaping fluid 14 decreases. As flow rate decreases the partial pressure selected by the user is approached and eventually the set point is reached and flow rate monitor 16 sends a signal to control unit 26. This signal indicates the desired partial pressure has been reached. Control unit then sends a signal to evacuation unit 20 to stop evacuating gas from container 12. In some aspects, flow rate monitoring unit 16 has a switch that is capable of closing a valve, which seals container 12, when the set point is reached, or control unit 26 can send a signal to a valve to close container 12 when flow rate monitoring unit 16 reaches a set point.

In some aspects of the invention, a bottle or similar container holding the fermented liquid is placed inside a vacuum chamber where the flow out of the chamber goes through monitoring unit 16. In such an embodiment a bottle would be opened, placed into the chamber, the chamber would be closed and then degassing of the liquid in the bottle would take place with the bottle in the airtight chamber. The flow rate monitoring unit 16 would be attached to the airtight chamber to monitor the flow rate of gasses leaving the fermented liquid in the bottle. As vacuum pressure reduces the pressure inside the chamber, the lower pressure in the chamber in lowered as well as the pressure in the bottle that is inside the chamber. This causes the pressure at the liquid-air boundary or interface of the fermented liquid to be lowered which causes outgassing to commence from the fermented liquid in the bottle. The flow rate of outgassing from the chamber is continuously monitored and/or measured until the set point for a flow rate is reached and the vacuum is halted. After the set point for flow rate is reached the chamber can be resealed, or the bottle of fermented liquid can be removed from the chamber.

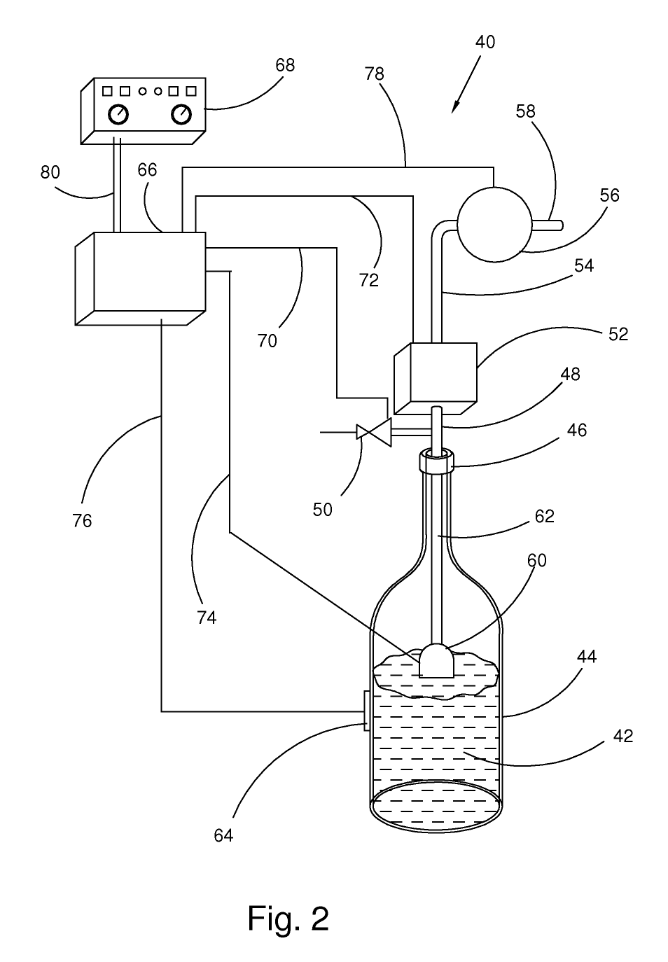

The present invention is represented schematically in another form in FIG. 2. The present invention provides an apparatus 40 and a related method. Similar to apparatus 10 in FIG. 1, apparatus 40 includes a device for monitoring or measuring the flow of gas escaping container 44, which has been outgassed from a fluid 42. Flow monitoring unit 52 is represented in FIG. 2 as a unit that is attached to container 44 with a cap 46. Cap 46 can be any securing means capable of removably attaching said cap 46 to said container 44. Removably means that cap 46 is attached in a way that enables device 40, and all components to be readily removed from container 44. In an aspect of the invention, cap 46 is removably attached to container 44 using a screw mechanism that enables cap 46 to have a female threading that interacts with a male threading on container 44, similar to a screw cap on a bottle. Other aspects of the invention can use a cap 46 or method of attachment such as a compression cap, clamp, screw thread, clamp on, vacuum suction, mechanical clamp on outside, expanding insert, adhesive, magnets, gravity, stopper, or cork, or some similar means that secures cap 46 to container 44 in a way that accomplishes a seal that is airtight or very close to airtight.

Apparatus 40 is intended to be attached to a container 44 holding a fluid 42, that has been very recently opened, and which may contain compounds that can be detrimental to the flavor and finish of the liquid. Fluid 42 is the substance that is to be degassed, and is any substance that can be outgassed to improve the flavor profile. Soon after opening container 44, a flow rate monitoring unit 52 is attached in a fashion that prevents any gasses that are outgassed from the liquid 42 from escaping container 44 without first flowing through or past flow rate monitoring unit 52. The attachment of apparatus 40 of the present invention to a container is intended to measure the flow rate of gasses outgassing from fluid 42. The objective of quickly attaching apparatus 40 and flow rate measurement unit 52 to container 44 is to reduce the degree that fermented liquid in container 44 is exposed to oxygen, and to accurately monitor the initial gas flow rate from the fermented liquid and the change in flow rate over time. In an aspect of the invention, unit 52 is attached to container 44 with a cap 46. Examples of container 44 on which apparatus 40, and its various components represented in FIG. 2, would be attached include, but are not limited to: flask, jug, bottle, tank, barrel, or any other vessel that is capable of holding liquid, including a chamber that can hold another container holding a fermented liquid.

One option maybe to have a segment 48, such as a tube, that separates attachment mechanism 46 from flow monitoring unit 52. This segment 48 may optionally have a pressure release valve 50, which is a valve that can opened to vent to the exterior of container 44 (e.g., venting to the atmosphere), or it can be closed to retain a pressure seal inside container 44. Once the degassing has proceeded to the optimal amount, and the evacuation unit 56 has been stopped, valve 50 can be opened manually, or valve 50 can be opened by control device 66 in order to equalize the pressure of container 44 with atmospheric pressure. This may be necessary if a vacuum has been formed inside container 44 from the functioning of evacuation unit 56. Equalizing the pressure in container 44 with the atmospheric pressure outside container 44 will enable any devices connected to container 44 to be removed, and will allow a user to remove fluid 42 from container 44. Release valve 50 relieves the vacuum in container 44 because the atmospheric pressure is greater than in the container and it reduces the effort to remove apparatus 40 from container 44. In some aspects, the surface area of the top of the container in contact with the apparatus 40 is small, or the vacuum effect may not be significant. Therefore, the force required to remove apparatus 40 would be small and relief valve 50 may not be necessary. In the case of large version of apparatus 40 being applied to a very large container 44, there would likely be a larger contact area, so the force would be larger in that case because force equals differential pressure times surface area, and a pressure relief valve 50 would be desirable.

In one aspect, control unit 66 sends a signal to the user that the desired partial pressure has been reached and illuminates an indicator and/or sounds a buzzer indicating the outgassing process has completed. Release of any vacuum developed within container 44 can be accomplished by: opening pressure release valve 50 manually; by pushing a button on control unit 66 to open pressure release valve 50; control unit 66 can open pressure release valve 50 when the desired partial pressure has been reached, or some variation of those methods.

Evacuation unit 56 is attached adjacent to, and in the same closed circuit as flow monitoring unit 52. This closed circuit is intended to be airtight. It is preferable that apparatus have an airtight seal between attachment mechanism (cap) 46, flow monitoring unit 52 and evacuation unit 56, and all components in that circuit. It is particular beneficial to have an airtight seal between attachment mechanism 46, flow monitoring unit 52 and evacuation unit 56, and all components in that closed circuit system when any pressure is applied by evacuation unit 56 and/or when mechanical perturbation is applied by units 60 and/or 64. In some aspects, evacuation unit 56 is separated from flow monitoring unit 52 by a segment 54, which can be tubing or similar material. Evacuation unit 56 can be a vacuum pump or a similar mechanism, which exposes fluid 42 to an ambient pressure that is lower than the partial pressure of any dissolved gasses, such as CO₂, in fluid 42. As ambient pressure surrounding the gas/liquid interface of fluid 42 becomes lower than the partial pressure of any dissolved gas in the fluid 42, that lower ambient pressure begins the evacuation (or outgassing) of gas from fluid 42. In one aspect of the invention, evacuation unit 56 is a vacuum pump that removes gas molecules from a sealed volume in order to leave behind a partial vacuum. In some aspects, evacuation unit 56 evacuates free gas molecules from container 44 through opening 58 as dissolved gas is outgassed from fluid 42 as free gas molecules. One example of a vacuum pump that would adequately suit the needs of evacuation unit 56 would be a positive displacement pumps that use a mechanism to repeatedly expand a cavity, allow gases to flow in from the chamber, seal off the cavity, and exhaust it to the atmosphere. The ambient pressure outside evacuation unit 56 is atmospheric pressure. One reason for implementing evacuation unit 56, such as a vacuum pump, is to prevent oxygen contact with fluid 42, which in the case of wine can lead to fading of the wine. Vacuum pump degassing allows a user to control the degassing process and ideally time the point when the wine or fluid has been properly degassed and is just right for consumption for an individual user.

Another optional mechanism that can assist in the outgassing process is an agitator 60 that is inserted inside container 44 and is in contact with fluid 42. Agitation of the fluid 42 facilitates the start of outgassing and/or the degree and pace that dissolved gasses are outgassed from the fermented liquid. The agitation process provides a mechanical stimulus that enables dissolved gasses to outgas. One aspect of agitator 60 can include a wand mechanism with a rod 62 that is moved in a stirring motion, or some random motion that imparts a mechanical perturbation to the fermented liquid in container 44. In an alternative form of the invention, an external agitator 64 can be used on its own or in conjunction with internal agitator 60 to impart a mechanical stimulus to a fermented liquid. External agitator 64 can be attached to container 44, or can be placed contiguous to container 44 to impart the intended mechanical energy. The mechanical energy imparted by internal agitator 60 and external agitator 62 can be a vibration, shaking or stirring, or some similar motion. Any device capable of imparting a force that disturbs the fermented liquid would be sufficient.

In an alternative embodiment of the present invention depicted in FIG. 2, a control unit 66 controls or monitors the individual elements of apparatus 40, namely: flow rate monitoring device 52, release valve 50, evacuation unit 56, agitators 60 and 64, and display unit 68. Control device 66 can also allow a user to control the process and adjust or stop the process when the correct residual partial pressure of the dissolved gas in solution in the fluid is reached based on the flow rate of the gas being degassed from the fluid. It may be optimal to include a control unit 66 in the disclosed apparatuses and methods wherein the unit 66 can allow settings to be input by a user, it can display results through indicators, it can have a digital display, and/or it can implement audible sounds to alert a user of important events. Display unit 68 can be integrated into control unit 66, or can be a standalone unit that receives and transmits information between control unit 66 and display unit 68 along communication link 80. In one aspect, control unit 66 also enables components of apparatus 40 to interact, where the speed and/or timing of operation of those components is adjusted based on the information/data that is sent and received from the individual components to control unit 66. Control unit 66 receives and transmits information from flow monitoring device 52 along communication link 72. Control unit 66 receives and transmits information from evacuation unit 56 along communication link 78. Control unit 66 receives and transmits information from agitator 60 along communication link 74. Control unit 66 receives and transmits information from agitator 64 along communication link 76. Control unit 66 receives and transmits information from release valve 50 along communication link 70.

Apparatus 40 has been shown as having separate elements, namely, attachment mechanism 46, release valve 50, flow monitoring unit 52, evacuation unit 56, and control unit 66, that are adjacent and connected, but are still separate elements. All or some of the elements schematically represented in FIG. 2 can be consolidated into a single unit that performs each function of the individual units.

Flow rate monitoring performed by units 16 and 52 can be performed in various ways. Whether agitators 22, 60 and 64 or evacuation units 20 and 58, are used by themselves, or in cooperation, the present invention measures the amount of outgassing, sometimes based on the flow rate of gas from the fermented liquid. The present invention measures or monitors the flow rate of gas outgassing from fermented liquid in numerous ways, and with numerous devices, that include, but is not limited to, the following: measuring the pressure drop across a known orifice; using an electronic mass flow meter; timing of flapper valve discharges; timing of bubbles passing through a liquid media; using a positive displacement flowmeter; and/or the various other methods and devices shown and described in this description and set forth in the figures, as well as the various known ways and devices to measure or monitor flow, or bulk fluid movement, whether that is gas or liquid.

The present invention provides methods and apparatuses that detect the degree or level of outgassing that has occurred in a fermented liquid by primarily sensing the flow rate of outgassed dissolved gas from the fermented liquid. There are various methods and apparatuses describe here to sense that rate of outgassing and the methods and apparatuses of the current invention enable a user to establish a set point with a range of increments when outgassing can be stopped. To alert the user when the set point has been reached a signal is transmitted. When the set point is reached, i.e., the desired range for the flow rate has been reached, the term transmitting a signal, or transmit a signal can refer to several different actions. These actions include: turning off any mechanical perturbation device and/or turning off any evacuation unit, producing an audible or visual signal, closing the container that has been outgassing. The audible or visual signal or alert includes a buzzer, light, color change, or some similar indication. The signal can be transmitted from a flow monitoring unit, a control unit, or a display. In one embodiment, the set point can trigger a shut off mechanism that stops the outgassing and seals the container that has been outgassed.

In one example of the apparatus of the present invention, a user attaches device 40 to a container holding a fluid and selects the desired level of partial pressure that the user desires to obtain for that fluid. After setting the desired partial pressure, i.e., the level of outgassing that is desired, a user would turn apparatus 40 on with a start button located on control unit 66. Optionally, pushing the start button illuminates a power on indicator. Turning apparatus 40 on sends a signal to evacuation unit 56 to commence the evacuation of gas from container 44, and sends the partial pressure setting input by the user to flow rate monitoring unit 52 and that unit starts to continuously monitor the partial pressure change of fluid 42. If an agitator 60 and/or 64 is included in apparatus 40, the start button would also send a signal to agitator 60 and/or 64 to commence the mechanical perturbation of fluid 42.

In one example of the invention, the desired partial pressure level is correlated to a pressure differential between container 44 and the exterior of the container, i.e., the atmospheric pressure at outlet 58. In such an example, flow rate monitoring unit 52 is a differential pressure switch monitoring the pressure difference on either side of the pressure differential switch, i.e., the pressure within container 44, and the pressure outside container 44. The differential pressure switch continuously monitors the pressure difference across the switch. As the partial pressure of dissolved gas in fluid 42 drops, due to outgassing of dissolved gas caused by the vacuum and/or mechanical perturbation, the flow rate of gas escaping fluid 42 decreases. As flow rate decreases the pressure drop across the differential pressure switch decreases until the set point is reached and the normally open differential pressure switch closes and sends a signal to control unit 66. This signal indicates the desired partial pressure has been reached. Control unit then sends a signal to evacuation unit 56 to stop evacuating gas from container 44.

In another example of the invention, the desired partial pressure level is correlated to a flow rate of gas evacuating from container 44. Flow rate monitoring unit 52 is a flow rate monitoring device that can detect or monitor the gas pressure that is exerted against unit 52 from container 44. The flow rate monitor continuously monitors the pressure from container 44. As the partial pressure of dissolved gas in fluid 42 drops, due to outgassing of dissolved gas caused by the vacuum and/or mechanical perturbation, the flow rate of gas escaping fluid 42 decreases. As flow rate decreases the partial pressure selected by the user is approached and eventually the set point is reached and flow rate monitor 52 sends a signal to control unit 66. This signal indicates the desired partial pressure has been reached. Control unit 66 then sends a signal to evacuation unit 56 to stop evacuating gas from container 44. If agitator 60 and/or 64 is used, control unit would also send a signal to stop mechanical perturbation when the set point has been reached. In some aspects, flow rate monitoring unit 52 has a switch that is capable of closing a valve when the set point is reached, or control unit 66 can send a signal to a valve to close the container when flow rate monitoring unit 52 reaches a set point.

The present system and method provides continuous real-time feedback on outgassing, and this information enables the automation of the outgassing process. While CO₂ specific electrodes could be used to provide continuous real-time information, those technique involve contact with the fluid being degassed and would be unfeasible if one desires to uses the container in which the liquid was purchased as the degassing container. There may be disadvantages, such as contamination concerns, to any apparatus or method that requires the inserting of a monitoring device into the liquid. Unlike the previous techniques, the present invention measures the flow rate of gases being outgassed, and therefore doesn't require a partial pressure detection mechanism to be in contact with the fermented liquid. The present method and apparatus measures flow rate of the outgassing gas, which provides correlated inferences of the quantity of dissolved gas through the entire outgassing process. Measuring the flow rate and the outgassing process throughout the entire process, enables one to determine when to stop outgassing to achieve the optimal residual gas levels to provide an optimal bouquet, complexity, balance and finish that can be tailored for each individual user.

The outgassing reaction rate can be affected by numerous drivers including level of agitation and the partial pressure of the dissolved gas in solution. In situ measurements of the outgassing reaction rate, all other factors constant, can be correlated to the partial pressure of the primary dissolved gas being removed. Terminating vacuum degassing (whether that degassing is enhanced in some way with mechanical perturbation or another way) at a flow rate correlated to a specific partial pressure will eliminate the potential adverse impact on bouquet, complexity, balance or finish of over evacuation.

The rate of outgassing is proportional to the partial pressure of the gas being degassed with all other variables constant. The rate of degassing is correlated to the flow rate of gaseous fluid being removed from the fermented liquid. A specific flow rate can be correlated to the optimal partial pressure of the dissolved gas. The vacuum degassing, whether or not it is enhanced, is halted at a specific flow rate to achieve a wine which has its flavor, bouquet, complexity, balance and finish optimized. As the flow rate of the outgassing dissolved gas slows it will be an indication that the liquid is approaching a partial pressure of the dissolved gas that is nearly equal to the partial pressure of that gas in ambient gaseous mixture surrounding the liquid. The timing when the partial pressure of the outgassing dissolved gas should be stopped can be approximated when the flow rate is nearing the flow rate correlated to the desired partial pressure of dissolved gas. Determining the flow rate of the outgassing of the dissolved gas enables a user to know when they desire to stop the degassing. The outgassing can then by stopped at a predetermined level, which may correlate directly to a point when the partial pressure of the dissolved gas is nearly equal to the partial pressure of that gas in ambient gaseous mixture surrounding the liquid, or at some point prior.

Fading of the flavor, bouquet, complexity, balance and finish of a fermented liquid can be prevented by measuring the flow rate in this manner. Fading normally occurs when wine is exposed to too much oxygen and/or the dissolved gasses in the fermented liquid have been excessively outgassed. The current system and method can incorporate a vacuum system to prevent fading as vacuum degassing prevents the excessive introduction of oxygen into the fermented liquid.

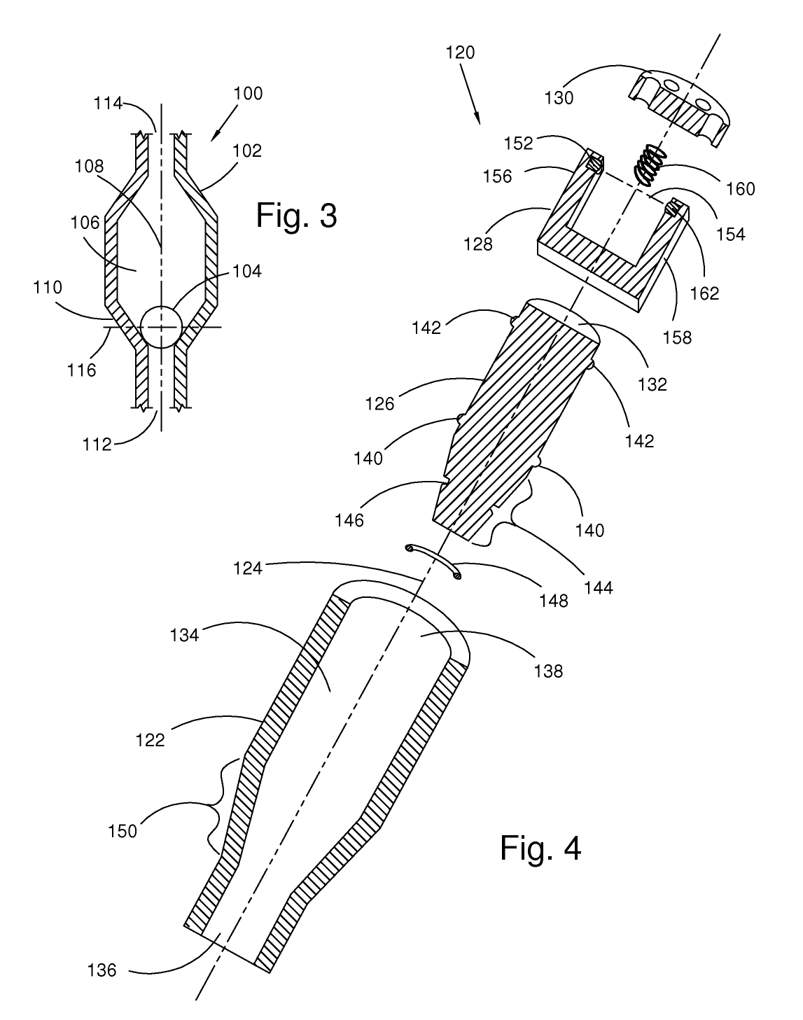

According to the present invention, FIG. 3 is a cross-sectional view of check ball valve 100, a device for monitoring the flow rate of gas that is outgassed from a fermented liquid. Check ball valve 100 is intended to be positioned adjacent to a container holding a fermented liquid at an outlet of a sealed container. Housing 102 can be attached adjacent to an opening/orifice of a container holding a fermented liquid prior to it being outgassed. Housing 102 is preferably attached proximate the opening of a container in a manner that is airtight. At both ends of housing 102 are openings that enable gas to flow through check valve 100. Inlet 112 is the end of check valve intended to be proximate an opening of a container holding a fermented liquid. Valve 100 is intended to be attached to a container using the methods and mechanisms described previously for attaching flow rate monitoring units 16 and 52.

Gas that is expelled or evacuated from a container connected to valve 100 will flow through inlet 112 and contact ball 104. If the pressure of the outgassing is sufficient to move ball 104 from a neck 110, a narrow region near inlet 112 of housing 102, gas will be expelled through outlet 114. The movement of ball 104 can be monitored to determine the rate of outgassing that is occurring or has occurred over a length of time. For instance, as ball 104 is moved, a detection device (not shown) can monitor and detect: the height of the movement, the duration that ball 104 is displaced from neck 110 into chamber 106, the number of times that ball 104 moves from neck 110 and returns to that position, the degree that ball 104 moves from center 108 of valve 100, and the monitoring device can measure the rate that any of those events occur. The amount of movement of ball 104 may be slight and it may be necessary to have a sophisticated detection device.

Outlet 114 may be exposed to atmospheric pressure, or it may be subjected to a vacuum that reduces the pressure outside of chamber 106. The pressure drop is intended to reduce the ambient pressure at the air-surface interface of the fermented liquid in the container that valve 100 would be attached, and this reduction in ambient pressure can be accomplished using techniques and apparatuses similar to evacuation units 20 and 56. In one aspect, where a vacuum is attached proximate outlet 114, the overall pressure in valve 100 would be lower, the gas would be less dense and more flow would be required to move ball 104. This is not critical in the effectiveness of valve 100 in monitoring the evacuation of the fermented liquid and flow rate of outgassing gas, as evacuation will be effecting the gas pressure in valve 100 (gas density) by approximately 20 percent, and the gas density will still be 80 percent of original. It should be noted that with outlet 114 exposed to atmosphere it would be an embodiment where sufficient mechanical perturbation would be used and no evacuation unit would be used to supply a vacuum.

In one aspect, housing 102 is manufactured using a clear material that would enable the visual observation of the movement of ball 104, as well as the manual recording of the speed, duration, rate, height and any other visually perceptible movement of ball 104.

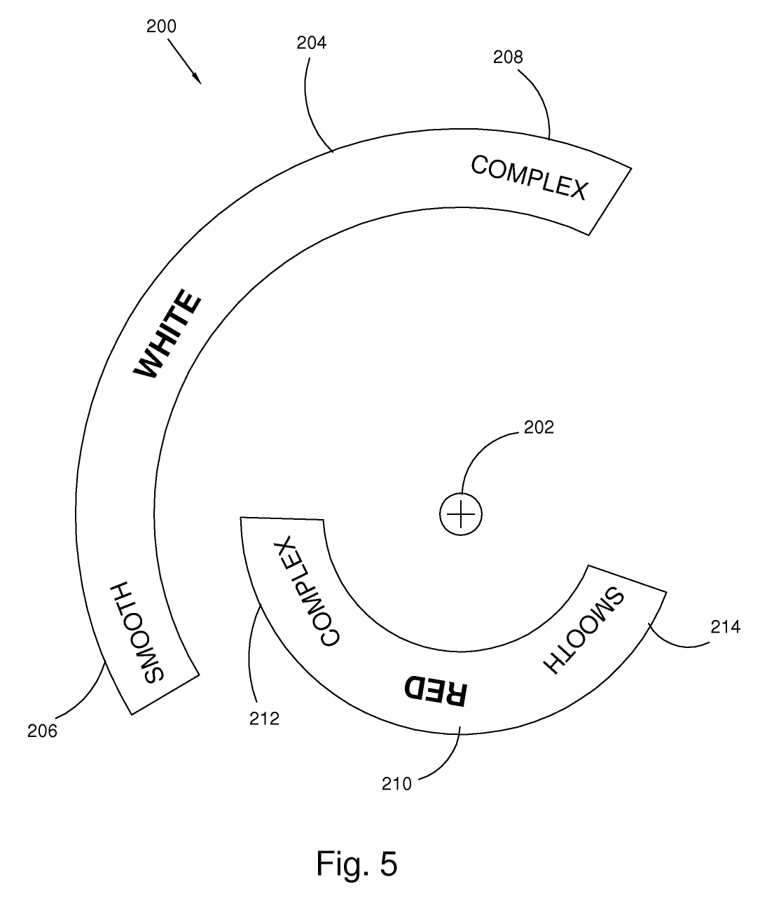

In another aspect of flow rate monitoring units 16 and 52, the flow rate monitoring is accomplished using switch assembly 120 schematically represented in a cross-sectional view shown in FIG. 4. Housing 122 is axially aligned with float 126 along axis 124, and float 126 is sized to fit inside housing 122. Float 126 can freely move inside housing 122 along axis 124. Switch assembly 120 includes a detection unit 128 positioned outside of housing 122.

In one example detection unit 128 is an optical coupler that utilizes a light beam emitter 152 that transits a light beam 154 between arms 156 and 158. Any opaque object that breaks light beam 154 will be sensed by detection unit 128 and can be recorded. Movement of float 126 is detected by detection unit 128 which is positioned outside housing 122. In another example of detection unit 128 it is an optical coupler with an LED on either arm 156 or 158, and a photo resister 162 positioned on the opposite arm that the LED is located. When the light beam 154 is broken and light fails to contact photo resister 162 the event is detected. In one aspect, float 126 is made of an opaque material that prevents or inhibits the flow of light. When the light beam is broken by float 126 detection unit detects that event. In another example float 126 is made of a clear or transparent material and the detection of its movement is done with a mechanical sensor or by the human eye.

In one embodiment, float 126 is cylindrically shaped with a tapered end 144. Float 126 rests within housing 122 in a chamber 134 of housing 122 that is roughly the same circumference or area of float 126, wherein the sides of float are proximate the inner walls of housing 122. Tapered end 144 includes a concentric o-ring groove 146 fitted with an accompanying concentric o-ring 148 that fit securely together. With float 126 properly inserted into housing 122 and in a start position, the tapered end 144 fits securely within tapered end 150 of housing 122 to form a seal. O-ring 148 will provide a seal that is airtight between the outer walls of tapered end 144 and the inner walls of the tapered region 150.

In one aspect, float 126 has at least one ridge 140, which is a narrow band that serves as buffer to prevent float 126 from resting directly against the inner wall of housing 122. In another aspect, a second ridge 142 is also used to further assist in preventing float 126 from resting directly against the inner wall of housing 122. Ridges 140 and 142 can be a concentric circular ridge on the entire exterior surface of float 126, or these ridges 140 and 142 can be bumps, or some similar protuberance, that are placed at positions around the circumference of float 126, which can randomly positioned on the outer surface of float 126, or ridges 140 and/or 142 can be regularly placed around the circumference of float 126. Ridges 140 and 142 are intended to reduce friction between float 126 and housing 122, and enable float 126 to travel freely within housing 122.

Positioned at the outlet 138 of housing 122 is retainer 130. With float 126 inside chamber 134 of housing 122, retainer 130 is secured proximate outlet 138 to retain float 126 inside housing 122. Retainer 130 is secured at the top of housing 122 proximate outlet 138. The securing of retainer 130 is accomplished with a reversible or non-reversible means, it is best that once secured retainer 130 is capable of preventing float 126 from exiting chamber 134 from gaseous pressure exerted through inlet 136. In one aspect, retainer 130 has perforations or apertures that enable gas and pressure in switch assembly 120 to be exhausted through those perforations or apertures. The size, number and positioning of the perforations or apertures is adaptable, and is selected to not inhibit the free movement of float 126 within chamber 134.

In one aspect of switch assembly 120, a spring 160, or similar compression device, is placed between top surface 132 of float 126 and retainer 130 to absorb the force from float 126 as it is moved along axis 124 within housing 122, and spring 160 returns float 126 to its start position with o-ring 148 of tapered region 144 in contact with inner surface of tapered region 150. Air pressure exerted through inlet 136, if sufficient, moves o-ring 148 and tapered region 144 of float 126 from contacting the inner wall of tapered region 150 of housing 122. That movement is detected by detection unit 128 and can be recorded, timed and/or measured.

In one embodiment of switch assembly 120, a detection element 128 is positioned proximate outlet 138 and the top 132 of float 126. As gas pressure exerted through inlet 136 impacts tapered region 144, float 126 begins to move and lifts from contact with the inner surface of tapered region 150 of housing 122. O-ring 148 is intended to create an airtight seal between tapered region 144 and inner wall of tapered region 150 to make certain that a small amount gas pressure entering inlet 136 will cause movement of float 126 even it is slight. It should be recognized that o-ring 148 and groove 146 can be eliminated in a simpler version of float 126, or a move complicated sealing components and system could be implemented. The range of differential pressure that would cause detectable movement in float 126 of switch 120 is dependent on the surface area of the tube opening in region 150 at point of contact with float 126, weight of float 126, angle between center line 124 of float 126 and vertical line and force exerted by compression device 160. The range that switch assembly 120 is designed to be moved or function, i.e., detect gas flow, is between 0.1 to 0.5 PSI differential, i.e., one tenth to five tenths of a pound per square inch differential pressure.

Housing 122 is intended to be connected to an opening in a container holding a fermented liquid proximate inlet 136 in a manner that will prevent loss of gas that may be outgassing from the fermented liquid. Gas that begins outgassing from the fermented liquid will exit the container and be directed through inlet 136 of switch assembly 120. In one aspect, an evacuation unit similar to that described for evacuation units 20 and 56 can be attached proximate to outlet 138. It should be noted that the function of switch 120 will be affected by the use of an evacuation unit, or vacuum unit attached proximate outlet 138. Evacuation units will affect flow rate and gas density in switch 120, which could lead to less pressure being required to cause float 126 to move. The switch assembly 120 and float 126 would be correlated to flow rate for either evacuated on non-evacuated use based on the embodiment of the device produced to account for any differences in flow rate and gas pressure caused by using an evacuation unit, or not using an evacuation unit in the presently disclosed outgassing methods and devices. Similarly, if an agitation mechanism is used to subject the liquid to a mechanical perturbation, the flow rate of the outgassing gas will be affected and flow switch 120 will react differently, and the preferable ranges of outgassing will be to be adjusted accordingly.

A flapper valve is another instrument that can be implemented, in a similar way that flow monitoring units 20 and 52 are shown and described, to measure or monitor the degassing flow rate of gas from a fermented liquid. The interval between discharges across the flapper valve is measured or monitored to determine when the process has optimally progressed. By monitoring the frequency, number of times a flapper valve moves, and the interval of that movement, the approximate flow rate is calculated. The flapper valve (not shown) consists of a cover with a sealing element around the exterior, wherein the cover rest over an opening that is proximate an inlet on the valve. The sealing element and cover form an airtight seal that prevents fluid from passing the inlet side of the cover unless it is sufficient to overcome the weight of the cover. The airtight seal of the sealing element and cover is a passive seal that can be overcome by a sufficient amount of gas pressure on the inlet side on the cover which is facing interior of a container and the fermented liquid inside. A flexible joint joins the cover of the flapper valve to a flapper valve housing and the joint enables the cover to flap open and close when pressure is exerted on the inlet side of the cover. The flapper valve is intended to be attached to a container proximate an orifice of the container that is emitting gas. The interior of the flapper valve faces the outgassing from a liquid. An outgassing liquid will emit a flow of outgassing fluid. The flapper valve could be held closed, in a start position, by gravity and/or a spring force. When closed no flow passes through the flapper valve. As degassing takes place in the container, due to mechanical perturbation, or due to something causing the ambient pressure of gasses dissolved in the liquid to lower, the pressure in the container is raised, and as pressure is elevated it can cause the flapper valve to be moved as the pressure on the inlet side of the valve exceeds the force holding the cover in the closed position. The cover is forced open and gas is discharged. The other side of the cover (outlet side) can either be open to atmosphere or vacuum (lowered pressure), and the presence of vacuum will affect the force necessary to move the cover of the flapper valve.

In some aspects of the flapper valve a sensing device can be implemented to detect the movement of the flapper valve. Sensing devices detect the movement of the flapper valve. Possible alternatives include: an optical element that utilizes a light beam, breaking an electric circuit, or some similar sensing mechanism. Each time the flapper valve moves the sensing element will record a discharge. The opening of the flapper valve equalizes the pressure on the outlet side of the cover and the inlet side of the cover, and the flapper (cover) is closed by gravity and/or spring force. This cycle can be repeated. The time between gas discharges is correlated to flow rate. When the partial pressure of the dissolved gasses drops, degassing flow rate slows, it takes longer to build enough pressure to open valve, and the interval between gas discharges increases. When the interval in flapper opening increases to the time correlated to the flow rate that correlates to the correct partial pressure, the process is completed, and the outgassing process can be stopped.

In another embodiment of the flow rate monitoring unit, the interval between bubble discharges through a fluid can be measured to determine when the degassing process has optimally progressed. The timing of bubbles through liquid medium enables our method to approximate the flow rate.

Another technique and apparatus for measuring the flow rate degassing is to use a positive displacement flowmeter to determine when the outgassing process has optimally progressed. In another aspect of the invention, instruments such as an electronic mass flowmeter can be used to measure flow rate.

This present invention also provides a method and apparatus that enables a user to continuously measure the partial pressure of dissolved gasses in a fermented liquid, and establish an optimal time to consume the fermented liquid that needs to be degassed before consumption. The partial pressure of a dissolved gas, or a combination of dissolved gasses, in a fermented liquid can vary, as can the amount of a time a user may wish to outgas the liquid. Fermented liquids can have a combination of dissolved gasses, or a fermented liquid may have just a single dissolved gas. It some instances even in the case where there is a combination of gasses dissolved in the fermented liquid, CO₂ will likely be the predominant gas in that combination. User preference would be along a spectrum. If a user preferred a mellower finish of a fermented liquid then user would want more degassing to occur before consuming the liquid. Should a consumer want more “bite” to the liquid or a different flavor profile, the fermented liquid would be degassed for a shorter period of time.

One embodiment of the present invention is a dial 200 that can be used to establish the set point, or the degree of degassing that the user would prefer to achieve which matches the individual user's preferred flavor profile. Dial 200 is attached proximate to a resistance potentiometer which is used to correlate specific positions on dial 200 to a specific amount of outgassing, i.e., flow rate. An adjustment of dial 200 will send a signal that adjusts the set point at which outgassing will be stopped, i.e., when the wine reaches the optimal level as chosen by the user. Set point can be linked to a flow rate that is monitored or measured using the various flow rate monitoring devices that are described. For example, in the case of a flapper valve, ball check valve, switch assembly with a float it may be the timing between discharges of outgassing, i.e., timing of movement of the flapper, ball or float, respectively. If mellow setting, smooth 206 or 214 is selected, the fermented liquid will attain a mellower taste which will correlate to a greater amount of outgassing. This point will correlate to a point when the time interval between movement of the flapper, ball or float will increase. Alternatively, in the case of a flapper valve, ball check valve, float the distance of sustained travel of the flapper, ball and/or float is measured and a mellower taste, more degassing, will be correlated to less sustained travel.

In one embodiment, a differential pressure switch may be used to detect flow rate, i.e., the stage of outgassing, and as the amount of degassing increases a lower differential pressure across the known orifice will be sensed. In one example dial 200 is set at smooth 206 (white), or smooth 214 (red) depending on the wine that is being consumed, and a signal is sent to a differential pressure switch setting the flow rate to be detected in a range that will alert the user when more outgassing has been completed. Alternatively, a if a user has chosen a position on dial 200, that is nearer complex 208, or complex 212, depending on the wine that is being consumed, a signal is sent to a differential pressure switch setting the flow rate to be detected in a range that will alert the user when less outgassing has occurred.

Flow rate is proportional, but not linearly proportional to partial pressure. Therefore, it is preferred that the resistance potentiometer will be a logarithmic one, or in the case of using a more sophisticated controller a linear resistance potentiometer would also be effective. In one embodiment, dial 200 is connected to a logarithmic resistance potentiometer, as dial 200 is turned to the direction of smooth 206, or smooth 214, the resistance increases which increases the set point of the simple R-C circuit connected to a timing chip which increases the time between detected events before the timing circuit would sense that degassing is complete and the wine is ready for consumption. When the interval between discharges is greater, the slower the flow rate, the lower the residual partial pressure of the gas dissolved in the liquid, and hence smoother the taste. If dial 200 is connected to a logarithmic resistance potentiometer, and dial 200 is turned to the direction of complex 208, or complex 212, the resistance decrease which decreases the set point of the simple R-C circuit connected to a timing chip which decreases the time between detected events before the timing circuit would sense that degassing is complete and the wine is ready for consumption. When the interval between discharges is less, the faster the flow rate, the higher the residual partial pressure of the gas dissolved in the liquid, and hence the more complex the taste.

Dial 200 would be used to adjust flow rate monitoring units 16 or 52 to set the degree of outgassing that would occur before an indicator would notify a user that the setting has been reached. In one aspect, dial 200 adjusts by rotating around axis 202. A user consuming a white wine would refer to spectrum range 204 and would adjust dial 200 proximate the smooth end 206 of spectrum dial 204 if a white wine was being consumed and the user preferred a lower partial pressure of dissolved gas (i.e., more outgassing time), or would rotate dial 200 proximate the complex end 208 of spectrum dial 204 if a white wine was being consumed and the user preferred a higher partial pressure of dissolved gas (i.e., less outgassing time). A user could also adjust the spectrum dial 204 along incremental points along that spectrum dial 204 to fine tune the outgassing to match their preferred taste. The consumer can “learn” where to set the spectrum dial 204 for the outgassing they prefer without having to consider things like outgassing period and rate.

In one embodiment of the invention dial 200 is connected to a flow rate monitoring unit, similar to 16 or 52, that measures the differential pressure across an orifice in a container. The differential pressure switch (not shown) is implemented in units 16 or 52, and has a pressure setting adjustment screw which is connected to the dial 200. In such an embodiment, a differential pressure across a known orifice is correlated to a flow rate by utilizing a differential pressure switch. Prior to exposing the differential pressure switch to a pressure or flow, a set point is established and the differential pressure switch is set to detect a specific flow rate range or pressure difference. As the partial pressure decreases, the flow rate decreases, the pressure across a known orifice decreases. The greater the flow rate, the greater the differential pressure. As the partial pressure set point (or range) is reached the flow rate decreases to the point that the pressure drop across the orifice drops and a differential pressure switch at the correct set point across the orifice will signal completion. This method and device would be implemented with or without evacuation, but is best suited to mechanical perturbation without evacuation. When implementing an evacuation source, the pressure on the evacuation side and the container side of a flow rate monitoring device it may be beneficial to equalize the pressure on either side of the flow rate monitoring unit. Therefore, measuring by differential pressure across a known orifice while using evacuation may still require equalization on either side of the pressure differential measuring device (known orifice), and the restriction across the known orifice can slow this equalization. One way to alleviate this complication is to implement a bypass of the known orifice (pressure differential measuring device) which is used as the pressure on either side of the orifice is equalized. This equalization will occur, but the time required to accomplish equalization without a bypass of the orifice may require more time.

One specific example of a differential pressure switch is an orifice plate which is a device used for measuring the volumetric flow rate. It uses the same principle as a Venturi nozzle, namely Bernoulli's principle which states that there is a relationship between the pressure of the fluid and the velocity of the fluid. When the velocity increases the pressure decreases and vice versa. An orifice plate is a thin plate with a hole in the middle. It is usually placed in a pipe in which fluid flows. When the fluid reaches the orifice plate, with the hole in the middle, the fluid is forced to converge to go through the small hole; the point of maximum convergence actually occurs shortly downstream of the physical orifice, at the so-called vena contracta point. As it does so, the velocity and the pressure changes. Beyond the vena contracta, the fluid expands and the velocity and pressure change once again. By measuring the difference in fluid pressure between the normal pipe section and at the vena contracta, the volumetric and mass flow rates can be obtained from Bernoulli's equation.

When degassing a white wine, dial 200 is adjusted toward the complex end 208 to obtain a higher partial pressure setting. The higher partial pressure setting leads to less degassing or more “bite”. When degassing a white wine, dial 200 is adjusted toward the smooth end 206 to obtain a lower partial pressure setting. The lower partial pressure setting leads to more degassing or smoother flavor and finish.

When degassing a red wine, dial 200 is adjusted toward the complex end 212 to obtain a higher partial pressure setting. The higher partial pressure setting leads to less degassing or more “bite”. When degassing a red wine, dial 200 is adjusted toward the smooth end 214 to obtain a lower partial pressure setting. The lower partial pressure setting leads to more degassing or smoother flavor and finish.

It should be apparent from FIG. 5 that the scale and range of ideal partial pressures for red wine is different than the scale and range of ideal partial pressures for white wine. The reason that the ideal range is different in reds and whites is that in a red wine there is natural acidity not related to CO₂, and white wine has less natural acidity related to dissolved CO₂ levels. If the dissolved CO₂ level of a red wine was not adjusted differently than a white wine, a red wine would have too much “bite” or taste bitter. Likewise, a white wine with much less natural acidity not related to CO₂ would taste “flat” of “flabby” if there was too little dissolved CO₂. The optimal range of CO₂ partial pressure at the time of consumption is higher for white wines because white wines contain lower natural acids as compared with red wines.

At a temperature of 68 degrees F. the following are the ranges of partial pressures that correlate to the scale for the ideal range on dial 200: For red wine the ideal range of partial pressure is 0.11 to 0.43 bar or 1.60 to 6.38 psia both these ranges are the partial pressure for the ideal amount of 200 to 800 mg/l. Smooth 206 and 214 being on one end of the range, and complex 208 and 214 being on the other end of the range. For white wine the ideal range of partial pressure is 0.38 to 0.98 bar or 5.59 to 14.4 psia both these ranges are the partial pressure for the ideal amount of 700 to 1800 mg/l. Smooth 206 and 214 being on one end of the range, and complex 208 and 214 being on the other end of the range. Dial 200 is expected to be correlated to these values and apparatus 10 and 40 can adjust from 0.11 to 0.98 bar. These values correlate to the amount (partial pressure) of CO₂ that should be in wine at time of consumption.

In one embodiments of dial 200, terms similar to those shown on dial 200 in FIG. 5 are imprinted on the dial to enable a user to know how to adjust the set point, i.e., the flow rate or pressure setting. In one example of dial 200, a simple numeric scale will be included on the both white range 204, and red range 210. This scale can be increments of 1-5, or 1-10, or some similar scale. One represents one end of the scale, less degassing; and 10 represents the other end of the scale, more degassing.

In another embodiment of the invention, the apparatuses depicted in FIGS. 1 and 2 are fully automatic. The consumer attaches an outgassing device of the present invention, similar to 10 or 40, to a container, chooses an outgassing setting (more or less outgassing), and presses a start button to commence the degassing process. The outgassing apparatus automatically stops when a desired partial pressure is reached and alerts the user that the wine is ready for consumption.

In another fully automated version of the outgassing device of the present invention, a user attaches the outgassing device on a container, the desire level of outgassing is dialed in on dial 200, and the user commences the outgassing process, by starting an evacuation unit and/or a mechanical perturbation unit. In one aspect, a “running” or “on” indicator illuminates when the process is commence and the unit is powered on. The outgassing is measured continuously after the outgassing process is started. In one aspect, the device monitors the degassing by measuring flow rate compared to a set point. Once the flow rate slows to the desired level, i.e., reaches the set point, the device automatically shuts off the evacuation and/or mechanical perturbation. An indicator or alert indicates that the liquid has reached the desired level of outgassing that was established at the set point. In one aspect, a timing unit dictates when the outgassing is stopped, and a user uses a timing element to select how long the outgassing process should be continued. In one example a wine ready indicator may illuminate, an audible alarm can sound, and a clamp securing the apparatus to the container can release. In some versions of the device a microprocessor can coordinate the various actions and can enable voice recognition and control and/or graphical displays.

The present invention also provides a manual version of the methods and apparatuses that allows the user to select a desired outgassing level. The consumer attaches the outgassing device on a container holding fermented liquid in a manner that removably clamps the device to the container proximate an orifice on the container. The consumer depresses a run button and holds the run button depressed which starts the outgassing process by turning on an evacuation unit and/or a mechanical perturbation unit. In one aspect, the set point is not adjustable. In another aspect, set point is adjusted by the user along various increments that fall within a range of acceptable degassing levels for a particular fermented liquid. When the flow rate, or outgassing set point has been reached, a buzzer or indicator notifies the user of the event and the user can release the run button and several possible events can occur including: stop outgassing, stop evacuation and/or mechanical perturbation, flow monitoring circuit is de-energized. The user can then unclamp and remove the outgassing device of the present invention.

In many aspects of the apparatuses and methods described herein, the partial pressure (or level of outgassing) is determined indirectly by measuring the degassing flow rate. That flow rate may be measured while the container of liquid being degassed is under a vacuum and/or the outgassing process is enhanced in another way, such as by mechanical perturbation. When the optimal partial pressure is reached, the degassing is terminated. Since every user has a different palate the optimal partial pressure may change, but the underlying goal of the disclosed method and apparatus is to enable a user to establish a target partial pressure for dissolved gasses in a fermented liquid and have it terminated at that point. The system and method enables a user to get just the right flavor profile without adversely impacting the unique bouquet, complexity, balance or finish that the individual user is seeking.

The various methods and apparatuses that are disclosed here attempt to take into account the subjective nature of wine and the consumers of wine. Different consumers will adjust the partial pressure set point according to their own preferences, and the present invention has adjustable elements that enable a user to get repeatable results based on their individual taste, i.e., the partial pressure of the gas or gasses dissolved in wine or another fermented liquid.

In Table 1 has the flow rates corresponding to the partial pressures for the dial settings for a standard 750 ml bottle, 5.9 in Hg vacuum and sonic excitement.

TABLE 1

| | | | Flow Rate at 5.9 in |
|---|---|---|---|
| | Milligrams | Partial | Hg Vacuum and |
| | CO₂ per | Pressure | Vigorous Sonic |
| Description of point | liter | CO₂ | Excitement |
| Maximum CO₂ in still | 3920 | 31.1 psia | 208 ml/min |
| wine per US standards | | | |
| Upper level of desired | 1800 | 14.4 psia | 64.7 ml/min |
| range for consumption | | | |
| of white wines | | | |
| Upper level of desired | 800 | 6.38 psia | 19.2 ml/min |
| range for consumption | | | |
| of red wines | | | |
| Lower level of desired | 700 | 5.59 psia | 15.7 ml/min |
| range for consumption | | | |
| of white wines | | | |
| Lower level of desired | 200 | 1.60 psia | 2.4 ml/min |
| range for consumption | | | |
| of red wines | | | |

The following description will provide specific examples of the present invention. Those skilled in the art will recognize that routine modifications to these embodiments can be made, which are intended to be within the scope of the invention.

What is claimed is:

1. A method of treating a fermented liquid, comprising:
exposing said fermented liquid to a stimulant to initiate outgassing of at least one gas dissolved in said fermented liquid;
continuous monitoring of a flow rate of said at least one dissolved gas outgassing from said fermented liquid; and,
stopping said outgassing of said at least one gas from said fermented liquid when said flow rate reaches a desired range.

2. The method of claim 1, wherein said desired range is about 2.4 ml/min to 64.7 ml/min.

3. The method of claim 1, wherein said dissolved gas is selected from a group consisting of CO₂ and SO₂.

4. The method of claim 1, wherein said stimulant is a vacuum that lowers ambient pressure at a liquid-air interface of said fermented liquid, wherein said ambient pressure is lower than a partial pressure of at least one gas dissolved in said fermented liquid.

5. The method of claim 4, further comprising a second stimulant that causes agitation of said fermented liquid to enhance said outgassing of said at least one dissolved gas from said fermented liquid.

6. The method of claim 5, wherein said agitation is indirectly applied to said fermented liquid.

7. The method of claim 1, wherein said stimulant causes agitation of said fermented liquid to enhance said outgassing of said at least one dissolved gas from said fermented liquid.

8. The method of claim 4, wherein said fermented liquid is held within a container that is airtight and said ambient pressure is lowered by lowering pressure outside said container.

9. The method of claim 1, wherein said outgassing occurs without introducing oxygen into said fermented liquid.

10. A method of treating a fermented liquid, comprising:
exposing said fermented liquid to an ambient pressure surrounding said fermented liquid that is lower than a partial pressure of at least one gas dissolved in said fermented liquid, wherein said lower ambient pressure initiates outgassing of at least one dissolved gas from said fermented liquid;
continuous monitoring of a flow rate of said at least one dissolved gas outgassing from said fermented liquid; and,
stopping said outgassing of said at least one gas from said fermented liquid when said flow rate reaches a desired range.

11. A device for treating a fermented liquid, comprising:
a perturbation unit, wherein said perturbation unit initiates outgassing from said fermented liquid;
a monitoring unit proximately connected to said perturbation unit, wherein said monitoring device continuously monitors a flow rate of dissolved gas outgassing from said fermented liquid; and
a signaling unit proximately connected to said monitoring device, wherein said signaling unit transmits a signal when said flow rate reaches a desired range.

12. The device of claim 11, wherein said perturbation unit is a vacuum pump that lowers an ambient pressure at a liquid-air interface of said fermented liquid to initiate outgassing from said fermented liquid.

13. The device of claim 11, wherein said perturbation unit is an agitator that mechanically perturbs said fermented liquid to initiate outgassing from said fermented liquid.

14. The device of claim 12, further comprising a second perturbation unit that is an agitator that mechanically perturbs said fermented liquid.

15. The device of claim 11, wherein said desired range is about 2.4 ml/min to 64.7 ml/min.

16. The device of claim 11, further comprising a closure that seals said container when said flow rate reaches said desired range.

17. The device of claim 11, further comprising a control unit connecting said perturbation unit, said monitoring unit and said signaling unit, wherein said control unit controls and coordinates all components in said device.

18. The device of claim 13, wherein said agitator is an eccentric motor.

19. The device of claim 18, wherein said agitator is positioned inside said fermented liquid.

20. The device of claim 18, wherein said agitator is positioned outside said fermented liquid.
